(19) United States
(12) Patent Application Publication
(10) Pub. No.: US 2024/0001866 A1
(43) Pub. Date: Jan. 4, 2024

(54) CEILING MATERIAL FOR VEHICLES

(71) Applicant: KASAI KOGYO CO., LTD., Kanagawa (JP)

(72) Inventors: Tatsumi ONISHI, Yokohama-shi, Kanagawa (JP); Lihao SHU, Ebina-shi, Kanagawa (JP)

(21) Appl. No.: 18/249,804

(22) PCT Filed: Oct. 23, 2020
(86) PCT No.: PCT/JP2020/039880

§ 371 Date: Apr. 20, 2023

(51) Int. Cl. B60R 13/02; B32B 7/12; B32B 15/09; B32B 3/26; B32B 5/18; B32B 5/02; B32B 27/40; B32B 27/12; B32B 15/20; B32B 27/36; B32B 27/06; B32B 15/04

(52) U.S. Cl. CPC B60R 13/0212; B32B 7/12; B32B 15/09; B32B 3/266; B32B 5/18; B32B 5/022; B32B 27/40; B32B 27/12; B32B 15/20; B32B 27/36; B32B 27/065; B32B 15/046; B32B 2605/003; B32B 2266/0278; B32B 2307/306; B32B 2307/202; B32B 2250/05

(57) ABSTRACT

Provided is a vehicle ceiling material that is lightweight and can be easily formed into a three-dimensional shape while maintaining rigidity. The vehicle ceiling material includes a base material, a skin material layer arranged at a surface on a vehicle interior side in the base material and forming a ceiling surface in a vehicle interior, an adhesive layer between the base material and the skin material layer, and a back surface layer arranged on a surface on a vehicle roof side in the base material. The adhesive layer and the back surface layer each include a layered film. The layered film includes a metal foil having a thickness of at least 10 μm and at most 100 μm and a resin film laminated with each other, and has an elongation percentage higher than that of the metal foil.

### CROSS-REFERENCE TO RELATED APPLICATIONS

This application is a National Stage Entry application of PCT International Application No. PCT/JP2020/039880, filed on Oct. 23, 2020, the entire contents of which are hereby incorporated by reference.

### BACKGROUND

### 1. Technical Field

The present disclosure relates to a vehicle ceiling material.

### 2. Description of the Background

A conventionally known vehicle ceiling material has a configuration in which a polyurethane foam, glass fiber layers on both sides of the polyurethane foam, and a back surface material or a skin material are layered in order, as disclosed in Japanese Patent Application Laid-open Publication No. 2013-79073 (hereinafter referred to as “Patent Literature 1”).

Another known vehicle ceiling material has a configuration in which a foamable phenol urethane mixed resin plate (used as a base material) and a reinforcing sheet (metal foil such as aluminum foil) are layered in order, as disclosed in Japanese Patent Application Laid-open Publication No. 561-102347 (hereinafter referred to as “Patent Literature 2”).

### BRIEF SUMMARY

When the glass fiber layer described in Patent Literature 1 is used, the glass fiber layer itself has a certain amount of weight, and thus, it is difficult to further reduce a weight of the vehicle ceiling material.

In view of it, it is conceivable to use, instead of the fiber reinforcing layer, the metal foil described in Patent Literature 2 and formed as a reinforcing sheet having a predetermined thickness, in order to reduce a weight of such a vehicle ceiling material. Use of the metal foil having the predetermined thickness and having an elastic modulus higher than that of the glass fiber layer can achieve weight reduction. Further, the same degree of rigidity as that of the vehicle ceiling material described in Patent Literature 1 can be secured.

However, it is conceivable that the metal foil cannot be stretched so as to be fitted with a three-dimensional shape of a vehicle ceiling material and results in being torn, and is unlikely to be formed easily.

The present invention has been made in view of such a circumstance. An object of the present invention is to provide a vehicle ceiling material that is lightweight and can be easily formed into a three-dimensional shape while maintaining rigidity.

In order to solve such a problem, a vehicle ceiling material according to the present invention includes a base material, a skin material layer, an adhesive layer, and a back surface layer. The skin material layer is arranged at a surface on a vehicle interior side in the base material and forming a ceiling surface in a vehicle interior. The adhesive layer is arranged between the base material and the skin material layer. The back surface layer is arranged on a surface on a vehicle roof side in the base material. At least one of the adhesive layer and the back surface layer includes a layered film. The layered film includes a metal foil and a resin film. The metal foil has a thickness equal to or larger than 10 μm and equal to or smaller than 100 μm. The metal foil and the resin film are laminated with each other so that the layered film has an elongation percentage higher than that of the metal foil.

According to the vehicle ceiling material of the present invention, the metal foil is used instead of a conventionally used heavy glass fiber layer, and the metal foil having a thickness equal to or larger than 10 μm and equal to or smaller than 100 μm and the resin film are laminated with each other. For this reason, the vehicle ceiling material can be formed so as to have a light weight, and can secure rigidity, and at the same time, can improve elongation of the metal foil. Thus, the three-dimensional shape can be easily formed while the rigidity is maintained with the light weight.

### BRIEF DESCRIPTION OF DRAWINGS

FIG. 1A is a top plan view illustrating a vehicle ceiling material according to the present embodiment.

FIG. 1B is a sectional view of the vehicle ceiling material illustrated in FIG. 1A.

FIG. 2A is a sectional view of a back surface layer of the vehicle ceiling material.

FIG. 2B is a sectional view of an adhesive layer of the vehicle ceiling material.

FIG. 3A is a sectional view of a back surface layer of a vehicle ceiling material according to a modified example 2.

FIG. 3B is a sectional view of an adhesive layer of the vehicle ceiling material according to the modified example 2.

### DETAILED DESCRIPTION

The following describes the present invention, based on a preferred embodiment. The present invention is not limited to the below-described embodiment, and can be appropriately modified without departing from the essence of the present invention. Although the illustration and description of some configurations are omitted in the below-described embodiment, it is a matter of course that publicly known or well-known techniques are appropriately applied to details of the omitted techniques within a range in which no contradiction occurs with the contents described below.

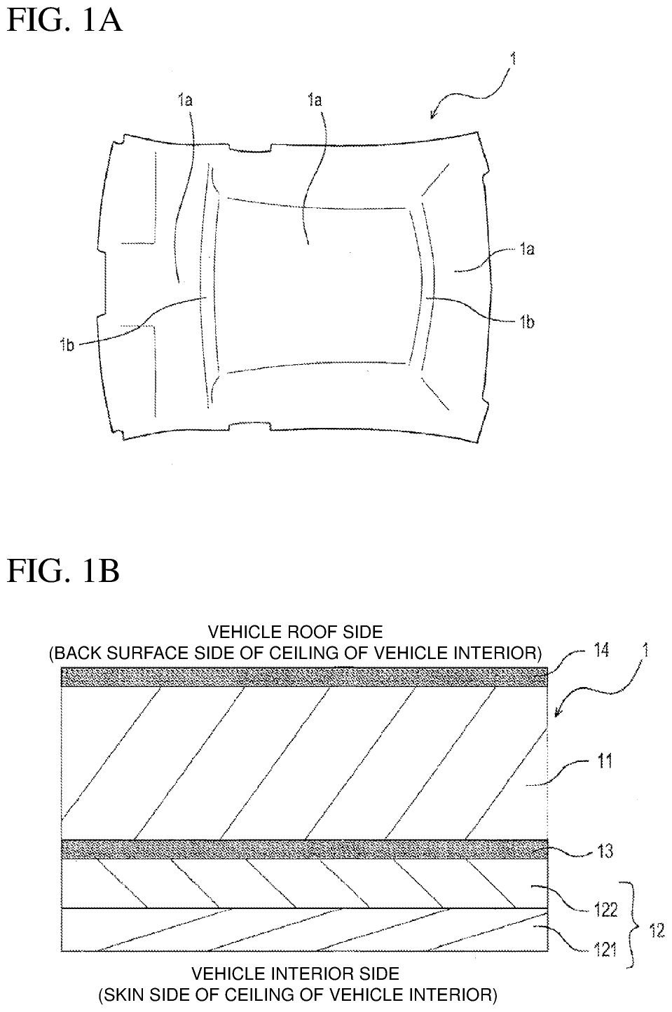

FIG. 1A is an upper plan view illustrating a vehicle ceiling material 1 according to the present embodiment. For example, the vehicle ceiling material 1 according to the present embodiment is attached to a vehicle roof portion (vehicle body) from an interior side of a vehicle. An electronic device (not illustrated) such as a map lamp unit is installed to such a vehicle ceiling material 1, and then, the vehicle ceiling material 1 is attached to the vehicle roof portion.

The vehicle ceiling material 1 illustrated in FIG. 1A includes flat portions 1a along the vehicle roof portion and stepped portions 1b extending in a vehicle up-down direction (so as to be inclined relative to the flat portions 1a). The flat portions 1a and the stepped portions 1b are produced by press working. Shapes of the flat portions 1a and the stepped portions 1b are designed from a shape of the vehicle roof portion, a relation with the install electronic device, and the like.

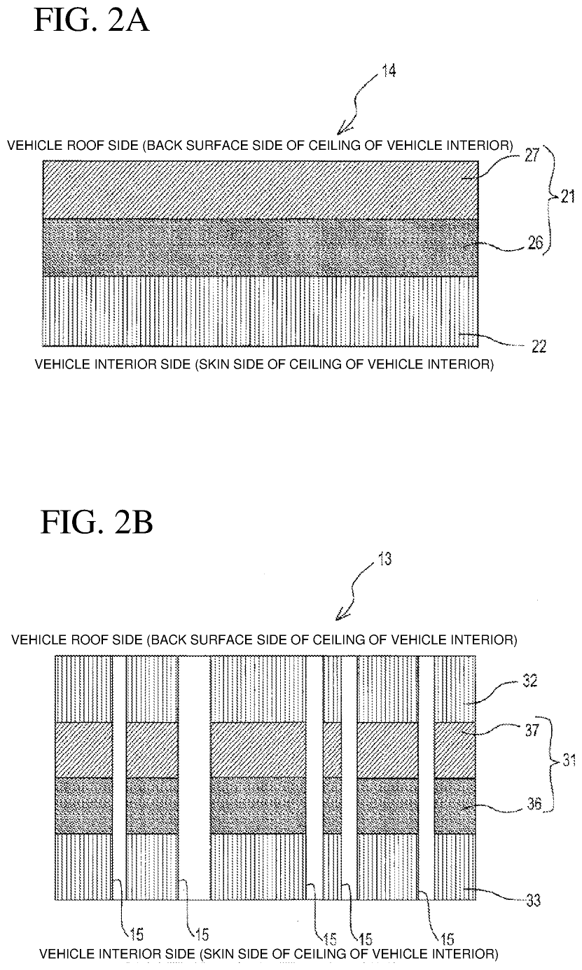

FIG. 1B is a sectional view of the vehicle ceiling material 1 illustrated FIG. 1A. FIG. 2A is a sectional view of a back surface layer 14. FIG. 2B is a sectional view of an adhesive layer 13. The vehicle ceiling material 1 includes a base material 11, a skin material layer 12, the adhesive layer 13, and the back surface layer 14, as illustrated in FIG. 1B. At some places in the following description, a back surface side of a ceiling of a vehicle interior is referred to as a vehicle roof side (or a back surface side), and a skin side of the ceiling of the vehicle interior is referred to as a vehicle interior side (or a skin side).

### Base Material and Skin Material Layer

The base material 11 is made of a urethane foam, for example.

The skin material layer 12 is arranged at a surface on a vehicle interior side (skin side) in the base material 11. The skin material layer 12 forms a ceiling surface in the vehicle interior. Generally, the skin material layer 12 includes a skin layer 121 such as cloth or nonwoven fabric, and a lamination urethane layer 122.

### Back Surface Layer

The back surface layer 14 is a portion arranged on a surface on a vehicle roof side (back surface side) in the base material 11 and supported from above by a bracket (not illustrated). The back surface layer 14 includes a layered film 21 and a hot-melt layer 22, as illustrated in FIG. 2A. The layered film 21 is arranged on a vehicle roof side, and the hot-melt layer 22 is arranged on a vehicle interior side.

### Layered Film

The layered film 21 is configured so as to include a metal foil 26 and a resin film 27 that are arranged in layers. The metal foil 26 and the resin film 27 are laminated with each other. The metal foil 26 and the resin film 27 are in a state of being firmly stuck to each other by being laminated with each other. An adhesive is used in the laminating in the present embodiment. However, pressure welding (a method of applying heat and pressure so that metal fusion causes atoms to be coupled to each other) may be used in the laminating.

The metal foil 26 in this lamination is used for heat shielding so as to prevent heat from being conducted from an outside to the vehicle interior. In the present embodiment, the metal foil 26 is arranged on a vehicle interior side, and the resin film 27 is arranged on a vehicle roof side.

An arrangement relation between the metal foil 26 and the resin film 27 can be also conceived such that either of them may be arranged on a vehicle roof side, and either of them may be arranged on a vehicle interior side. However, the hot-melt layer 22, the metal foil 26, and the resin film 27 are arranged in this order from below so that the metal foil 26 is sandwiched between the hot-melt layer 22 and the resin film 27. For this reason, the metal foil 26 has a reduced area exposed to outside air, and a rusting phenomenon of the metal foil 26 is suppressed. Particularly, when an upper surface of the layered film 21 is attached to an unillustrated bracket at the ceiling of the vehicle, covering an upper surface of the metal foil 26 with the resin film 27 results in that a back side in the metal foil 26 is unlikely to rust.

In the case of a configuration where the vehicle ceiling material 1 is stuck to an unillustrated bracket at the vehicle ceiling, the resin film 27 is more easily attached to the unillustrated bracket than the metal foil 26. Thus, the resin film 27 is preferably arranged on a vehicle roof side of the metal foil 26.

The metal foil 26 having high electrical conductivity is not exposed on a surface. For this reason, when an electronic device is arranged on a back surface of the ceiling of the vehicle interior, concern for a short circuit can be excluded.

### Metal Foil

An aluminum foil (AL foil) for example is used as the metal foil 26. A copper foil or another metal foil may be used as the metal foil 26. A reason for using the aluminum foil as the metal foil 26 is that the aluminum foil has low specific gravity and high rigidity, and cost of the aluminum foil is low. Adhering the metal foil to a surface of the base material 11 eliminates necessity of adhering a glass fiber layer to a surface of the base material 11 as in the conventional case. Thus, a weight of the vehicle ceiling material 1 can be reduced. Using the layered film 21 instead of the heavy glass fiber layer can reduce a weight of the vehicle ceiling material 1 by at least 20% from that of a conventional vehicle ceiling material.

The metal foil 26 has a thickness set within a range equal to or larger than 10 μm and equal to or smaller than 100 μm. This is because when the metal foil 26 is thinner than 10 μm, the metal foil 26 lacks rigidity, and when the metal foil 26 is thicker than 100 μm, the metal foil 26 is heavy. More preferably, the metal foil 26 has a thickness set within a range equal to or larger than 20 μm and equal to or smaller than 50 μm. The metal foil 26 having a thickness of 20 μm is used in the present embodiment. A thickness of the metal foil 26 is selected depending on target rigidity.

### Resin Film

The resin film 27 is used for improving formability of the metal foil 26. The resin film 27 has an elongation percentage higher than that of the metal foil 26.

The resin film 27 is laminated with the metal foil 26 for the following reason. The metal foil 26 alone is uniformly elongated up to a predetermined ratio by a load of tensile force, and is not easily elongated beyond the predetermined ratio. When a further load is applied to the metal foil 26 in that state, the metal foil 26 is torn. Thus, when the metal foil 26 alone is attached to the base material 11, the metal foil 26 does not easily follow an uneven shape of the base material 11, due to the elongation property of the metal foil 26, 36, and the metal foil 26 is easily torn by application of tensile force. Therefore, in a conceivable case, use of the metal foil 26 restricts a development rate, resulting in difficulty with deep drawing or the like.

In contrast to this, the layered film 21 in which the metal foil 26 and the resin film 27 are laminated with each other makes it easy to uniformly elongate the metal foil 26 along with elongation of the resin film 27. The layered film 21 can be elongated at a high elongation percentage of 40% to 50% in a machine direction (MD) and in a transverse direction (TD) even at a room temperature. When hot-pressed by heat of 140° C. to 150° C., the layered film 21 can be even more elongated. For this reason, the layered film 21 including the metal foil 26 and the resin film 27 can be attached to the base material 11 while following the uneven shape of the base material 11 better than in the case of the metal foil 26 alone. Thus, the layered film 21 is not easily torn even when tensile force is applied thereto. For example, the layered film 21 can be attached to the base material 11 while suitably following a recess portion of a sun visor storage portion, a recess portion of an assist grip storage portion, and the like. Thus, using the layered film 21 including the metal foil 26 laminated with the resin film 27 improves forming easiness.

The resin film 27 has a thickness set within a range equal to or larger than 10 μm and equal to or smaller than 100 μm. When a thickness of the resin film 27 exceeds 100 μm, treating of the resin film 27 becomes difficult. Thus, a thickness of the resin film 27 is desirably equal to or smaller than 100 μm. More preferably, the resin film 27 has a thickness set within a range equal to or larger than 20 μm and equal to or smaller than 50 μm. In the present embodiment, the resin film 27 having a thickness of 25 μm is used.

The resin film 27 preferably has a melting point equal to or higher than 120° C. in consideration of a temperature at the time of hot-pressing. In the present embodiment, the resin film 27 is made of a material whose main component is polyester and that has a melting point of 250° C. to 260° C. The resin film 27 may be made of nylon or another material. The resin film 27 having a melting point higher than that of the hot-melt layer 22 is used in order that the hot-melt layer 22 is melted and adhered while the resin film 27 is not melted and maintains a stress-strain diagram thereof.

### Hot-Melt Layer

The hot-melt layer 22 preferably has a melting point equal to or higher than 110° C. in consideration of a normal use environment of automobiles. The hot-melt layer 22 needs to be used at a temperature lower than a melting point of the resin film 27, since the resin film 27 cannot exhibit its original function when melted.

A polyester-based material is used for the hot-melt layer 22 in the present embodiment. A modified material of polyethylene (PE), polypropylene (PP), polyethylene terephthalate (PET), polyamide (PA whose example may be nylon), urethane, or the like may be used as a material of the hot-melt layer 22. However, the PA-based or PET-based material among these is preferable. A hot-melt film or a reactive hot-melt that each have a melting point higher than a temperature of a use environment is used for the hot-melt layer 22 so as not to affect heat resistance in practical use. In the present embodiment, the hot-melt layer 22 is melted, and is cooled and solidified so as to be adhered, and no harmful gas is generated. For this reason, there is no necessity of exhaust equipment having such high performance as that required in the case of using conventional isocyanates and amine.

In the present embodiment, a polyester-based material having a melting point of 110° C. is used for the hot-melt layer 22. However, a material having a melting point equal to or higher than 100° C. and lower than that of the resin film 27 may be used for the hot-melt layer 22. For example, the hot-melt layer 22 preferably has a melting point equal to or higher than 100° C. and equal to or lower than 160° C. When the hot-melt layer 22 is melted while a user is normally in the automobile, the base material 11, the adhesive layer 13, and the skin material layer 12 fall (slip down). For this reason, the hot-melt layer 22 needs to have a melting point equal to or higher than 100° C. Since the hot-melt layer 22 needs to be melted by heat earlier than the resin film 27, the hot-melt layer 22 needs to have a melting point lower than that of the resin film 27.

The hot-melt layer 22 is set so as to have a thickness within a range equal to or larger than 10 μm and equal to or smaller than 200 μm. When the hot-melt layer 22 has a thickness smaller than 10 μm, the adhesiveness to the base material 11 is lowered (entering into cells of the base material 11 becomes less), which is not desirable. More preferably, the hot-melt layer 22 is set so as to have a thickness within a range equal to or larger than 30 μm and equal to or smaller than 100 μm. The hot-melt layer 22 used in the present embodiment has a thickness of 40 μm to 50 μm. The hot-melt layer 22 is laminated with the metal foil 26, and is press-formed in a state of being melted. Thereby, an entire surface of the metal foil 26 is chemically bonded to the base material 11. The hot-melt layer 22 and the metal foil 26 may be arranged simply in layers without being laminated with each other, and may be press-formed.

### Adhesive Layer

The adhesive layer 13 is arranged between the base material 11 and the skin material layer 12 as illustrated in FIG. 1B, and has an adhesive function of adhering them to each other. The adhesive layer 13 includes a layered film 31 and hot-melt layers 32 and 33 as illustrated in FIG. 2B. The hot-melt layer 32, the layered film 31, and the hot-melt layer 33 are arranged in this order from a vehicle roof side.

### Layered Film

The layered film 31 is configured so as to include a metal foil 36 and a resin film 37 that are arranged in layers. The metal foil 36 is set so as to have a thickness equal to or larger than 10 μm and equal to or smaller than 100 μm. The resin film 37 has an elongation percentage higher than that of the metal foil 36.

In the present embodiment, configurations of the metal foil 36 and the resin film 37 are similar to those of the metal foil 26 and the resin film 27. However, the configurations of the metal foil 36 and the resin film 37 do not need to be exactly the same as those of the metal foil 26 and the resin film 27, and are allowed to be changed in thicknesses and in the order of the layers.

For example, a thickness of the metal foil 36 may be different from a thickness of the metal foil 26, and a thickness of the resin film 37 may be different from a thickness of the resin film 27.

When the resin film 27 and the metal foil 26 are arranged in this order from a vehicle roof side, the order may be reversed from this such that the metal foil 36 and the resin film 37 are arranged in this order from a vehicle roof side. Alternatively, when the metal foil 26 and the resin film 27 are arranged in this order from a vehicle roof side, the order may be reversed from this such that the resin film 37 and the metal foil 36 are arranged in this order from a vehicle roof side.

### Hot-Melt Layer

The hot-melt layer 32 adheres the layered film 31 and the base material 11 to each other. The hot-melt layer 33 adheres the layered film 31 and the skin material layer 12 to each other. The hot-melt layers 32 and 33 are made of a polyester-based material having a melting point of 110° C. in the present embodiment, but may be made of a material having a melting point equal to or higher than 100° C. and lower than that of the resin film 37. When the hot-melt layers 32 and 33 are melted while a user is normally in the automobile, the adhesive layer 13 and the skin material layer 12 fall (slip down). For this reason, the hot-melt layers 32 and 33 need to each have a melting point equal to or higher than 100° C. Since the hot-melt layers 32 and 33 need to be melted by heat earlier than the resin film 37, the hot-melt layers 32 and 33 need to each have a melting point lower than that of the resin film 37.

Particularly, the hot-melt layer 32 contacting with the resin film 37 is made mainly of the same material as that of the resin film 37. For example, when the resin film 37 is made of polyester, the hot-melt layer 32 is made of a composition in which polyester is a main component and is copolymerized with another material. In this case, the hot-melt layer 32 has a melting point lower than that of polyester alone because of the copolymerization of a polyester portion and a portion other than the polyester portion. Accordingly, the hot-melt layer 32 is melted at the lower temperature, and is cooled and solidified so as to be adhered to the base material 11. The hot-melt layer 32 and the resin film 37 preferably have solubility parameters (SP values) close to each other.

A plurality of holes 15 are formed in the adhesive layer 13. In the present embodiment, a plurality of the holes 15 each have a diameter equal to or smaller than 1 mm, and are formed at a pitch of 1 cm to 2 cm, but may be formed so as to have any of other diameters and be at any of other pitches. A plurality of the holes 15 may be configured in accordance with the formula based on the Helmholtz resonance. A sound in the vehicle interior passes through the skin material layer 12 and the holes 15 of the adhesive layer 13, and is absorbed inside the cells of the base material 11. A plurality of the holes 15 and the base material 11 form a resonator-type sound absorbing structure, and can absorb a sound with target sound absorbing performance. A combination of a diameter and a pitch of the holes 15 is adjusted depending on a required degree of sound absorption.

In a conventional vehicle ceiling material, a glass fiber layer attached to a lower surface of a base material includes voids. However, in the vehicle ceiling material 1 of the present embodiment, simply attaching a metal foil to a lower surface of the base material 11 results in that the metal foil reflects a sound, making it difficult for the base material 11 to absorb the sound. For this reason, in the vehicle ceiling material 1 of the present embodiment, a plurality of the holes 15 are necessary for the metal foil 36. When a plurality of the holes 15 are not provided, a sound can reverberate without being absorbed by the base material 11 in the case of conversation in the vehicle interior.

### Manufacturing Method

The following is assumed as a manufacturing method for the vehicle ceiling material 1. The skin material layer 12, the adhesive layer 13, the base material 11, and the back surface layer 14 described above are superimposed on each other so as to constitute a layered body. The layered body is hot-pressed such that the layered body is heated and softened, and the hot-melt layers 22, 32, and 33 are melted, and the layered body is pressed by an unillustrated pressing machine. Thereby, the vehicle ceiling material 1 is manufactured.

Alternatively, the vehicle ceiling material 1 may be manufactured by cold pressing as follows. The adhesive layer 13 and the back surface layer 14 are previously heated so that the hot-melt layers 22, 32, and 33 are melted. Then, in this melted state, the skin material layer 12, the adhesive layer 13, the base material 11, and the back surface layer 14 are superimposed on each other and pressed by an unillustrated pressing machine. Thereby, the vehicle ceiling material 1 is manufactured.

Alternatively, at the time of the above-described cold pressing, an unillustrated pressing die provided with a high-frequency induction heating apparatus may be used. In this case, the adhesive layer 13 and the back surface layer 14 are previously heated (induction-heated) by an unillustrated coil of the high-frequency induction heating apparatus so that the hot-melt layers 22, 32, 33 are melted.

As described above, the vehicle ceiling material 1 of the present embodiment includes the base material 11, the skin material layer 12, the adhesive layer 13, and the back surface layer 14. The skin material layer 12 is arranged at the surface on a vehicle interior side in the base material 11, and forms the ceiling surface in the vehicle interior. The adhesive layer 13 is arranged between the base material 11 and the skin material layer 12. The back surface layer 14 is arranged on the surface on a vehicle roof side in the base material 11. Each of the adhesive layer 13 and the back surface layer 14 includes the layered film 21 or 31. Each of the layered film 21 and 31 includes the metal foil 26 or 36 and the resin film 27 or 37. The metal foils 26 and 36 each have a thickness equal to or larger than 10 μm and equal to or smaller than 100 μm. The metal foil 26 or 36 and the resin film 27 or 37 are laminated with each other so that the metal foils 26 and 36 each have an elongation percentage higher than that of the metal foil 26 or 36.

According to the configuration of the present embodiment, the vehicle ceiling material 1 uses the metal foils 26 and 36 instead of conventionally used heavy glass fiber layers (organic fiber layers). The metal foils 26 and 36 each having a thickness equal to or larger than 10 μm and equal to or smaller than 100 μm are laminated with the resin films 27 and 37. For this reason, the vehicle ceiling material 1 can be formed so as to have a light weight, and can secure rigidity, and at the same time, can improve elongation of the metal foils 26 and 36. Thus, the three-dimensional shape can be easily formed while the light weight and the rigidity are maintained.

In the present embodiment, the layered film 21 is used as the back surface layer 14, and the resin film 27 is arranged on a vehicle roof side of the metal foil 26. According to such a configuration, when the layered film 21 is attached to a bracket (not illustrated) of the vehicle ceiling, the resin film 27 is arranged (at an uppermost portion of the vehicle ceiling material 1) on a bracket (not illustrated) side of the metal foil 26. Thereby, the resin film 27 suppresses a rusting phenomenon of the metal foil 26. The resin film 27 has better adhesiveness to the bracket (not illustrated) than the metal foil 26. Thereby, the layered film 21 can be stably fixed to the vehicle ceiling.

In the present embodiment, the layered film 31 is used in the adhesive layer 13, and the skin material layer 12 and the base material 11 are adhered to each other by the hot-melt layers 32 and 33. The hot-melt layer 32 contacting with the resin film 37 in the adhesive layer 13 is mainly made of the same material as that of the resin film 37. According to such a configuration, the resin film 37 and the hot-melt layer 32 includes the same material. For this reason, adhesiveness of the hot-melt layer 32 to the resin film 37 is improved.

In the present embodiment, the layered film 21 is used as the adhesive layer 13, and a plurality of the holes 15 connecting the skin material layer 12 and the base material 11 to each other are formed in the adhesive layer 13. According to such a configuration, the formation of a plurality of the holes 15 in the adhesive layer 13 causes a sound to pass through a plurality of the holes 15 and to be absorbed by the base material 11. Thus, a sound absorbing property is improved.

Meanwhile, if no holes 15 are formed in the adhesive layer 13, a sound can reverberate by the metal foil 36 included in the adhesive layer 13.

Hereinafter, the advantageous effects of the vehicle ceiling material 1 of the present embodiment are described in more detail.

### High Rigidity

The vehicle ceiling material 1 includes the high-rigidity metal foils 26 and 36 whose entire surfaces are adhered to the base material 11, and thus, can have rigidity set to be high. The metal foils 26 and 36 are adhered to both surfaces of the base material 11 by the hot-melt layers 22 and 32. The metal foil 36 is adhered to the skin material layer 12 by the hot-melt layer 33. For this reason, chemical bonding and a physical anchor effect enhance adhesiveness, and achieve high rigidity. The chemical bonding occurs when the hot-melt layers 22, 32, and 33 are melted and solidified. The physical anchor effect is an effect that the hot-melt layers 22, 32, and 33 uniformly enter fine holes in the surface of the base material 11 and in a surface of the lamination urethane layer 122 at a skin back surface.

Meanwhile, conventionally, the vehicle ceiling material 1 includes a glass fiber layer or an organic fiber layer adhered to the base material 11, and thus, has low rigidity. In other words, the conventional glass fiber layer or organic fiber layer includes voids formed therein, and thus, cannot be adhered to the base material 11 over an entire surface. For this reason, conventionally, uniform and high rigidity is not easily achieved. In addition, conventionally, an among of an adhesive needs to be adjusted for a portion having the lowest strength, and thus, the used amount is large.

### High Adhesiveness

The vehicle ceiling material 1 includes the metal foil 26 whose surface is flat and smooth, and thus, a large adhesion area is secured between the metal foil 26 and the base material 11, and adhesiveness of the metal foil 26 to the base material 11 is improved.

Meanwhile, in a conventional structure including a glass fiber layer stuck to a base material, a surface of the glass fiber layer is uneven, and a surface of the base material is adhered nonuniformly to the glass fiber layer.

### Reduction of Adverse Effect on Worker's Health

The vehicle ceiling material 1 includes the hot-melt layers 22, 32, and 33 to be melted and solidified and thereby adhered, and thus, hardly generates a harmful substance or a harmful gas. Accordingly, an adverse effect on an environment is reduced.

Meanwhile, conventionally, a glass fiber layer is used, which can inflict an adverse effect on an environment. In addition, chemicals (such as phenol, isocyanate, and amine) are used for adhering the glass fiber layer to a base material. Accordingly, odors and volatile organic compounds (VOCs) generated by the chemical reaction of the chemicals can inflict an adverse effect on an environment.

### Decrease on Manufacturing Time

The vehicle ceiling material 1 is formed by melting and cooling and solidifying the hot-melt layers 22, 32, and 33. For this reason, the manufacturing time can become shorter than in the conventional case. The metal foils 26 and 36 function as heat sinks by air flow application thereto after the hot-pressing. Thus, a cooling speed is further increased.

Meanwhile, conventionally, in the case of the forming where a glass fiber layer is made to include isocyanate for example, and water and amine are sprayed thereto, it is necessary to wait until the curing by the chemical reaction. For this reason, the manufacturing time is long. In addition to this, after the glass fiber layer is made to include isocyanate, prompt layering and forming are necessary because of the high reactiveness and the short allowable storage time. Further, after water and amine are sprayed, isocyanate is solidified in a still shorter time before the forming, and the glass fiber layer cannot be adhered to the base material 11 in some cases. Thus, working efficiency is worse.

Conventionally, for example, in a configuration in which a back surface and a front surface of a base material are sandwiched between two glass fiber layers, the two glass fiber layers are coated and impregnated with isocyanate, and at the time of the adhering, amine diluted with water is sprayed to a base material side by a spray or the like. Then, the amine water in the base material reacts with isocyanate in the glass fiber layers to generate urea so that the base material and the glass fiber layers are bonded to each other. When the glass fiber layers are attached to the base material by hot-press forming, a waiting time of 20 seconds to 30 seconds is necessary until the sticking is completed.

### Decrease in Thickness of Vehicle Ceiling Material

Since the metal foil 26 and the metal foil 36 are used instead of two glass fiber layers, the vehicle ceiling material 1 can be made thinner and lighter. Thus, a degree of freedom in interior design using the vehicle ceiling material 1 is increased. Selecting the high-rigidity metal foils or increasing thicknesses of the metal foils can further decrease a thickness of the vehicle ceiling material 1. Thus, a degree of freedom in interior design is improved.

### High Adhesiveness

The vehicle ceiling material 1 includes the metal foils 26 and 36 that are laminated with the hot-melt layers 22, 32, and 33 and that are pressed to the base material in a state where the hot-melt layers 22, 32, and 33 are heated and melted before the attaching to the base material 11. Thereby, high adhesive strength can be achieved by uniformly making the chemical bonding based on material compatibility and the physical bonding based on the entering into the cells. In addition, using the hot-melt layers 22, 32, 33 enables the adhesion by a simple method of the melting of the hot-melt layers and the pressing.

Meanwhile, conventionally, a vehicle ceiling material includes a large number of glass fiber layers or organic fiber layers, and surfaces thereof are not uniform. For this reason, a large amount of an adhesive is necessary for achieving high adhesiveness. In addition, the chemical reaction is used, and thus, it takes time for the adhesive to be cured.

### Modified Example 1

In the above-described embodiment, both of the adhesive layer 13 between the base material 11 and the skin material layer 12, and the back surface layer 14 are formed so as to include the layered films 21 and 31. However, there is no limitation to the above-described embodiment. For example, only the adhesive layer 13 between the base material 11 and the skin material layer 12 may be formed so as to include the layered film 21. Alternatively, only the back surface layer 14 may be formed so as to include the layered film 31. From the above, at least one of the adhesive layer 13 between the base material 11 and the skin material layer 12, and the back surface layer 14 may be formed so as to include the layered film 21.

### Modified Example 2

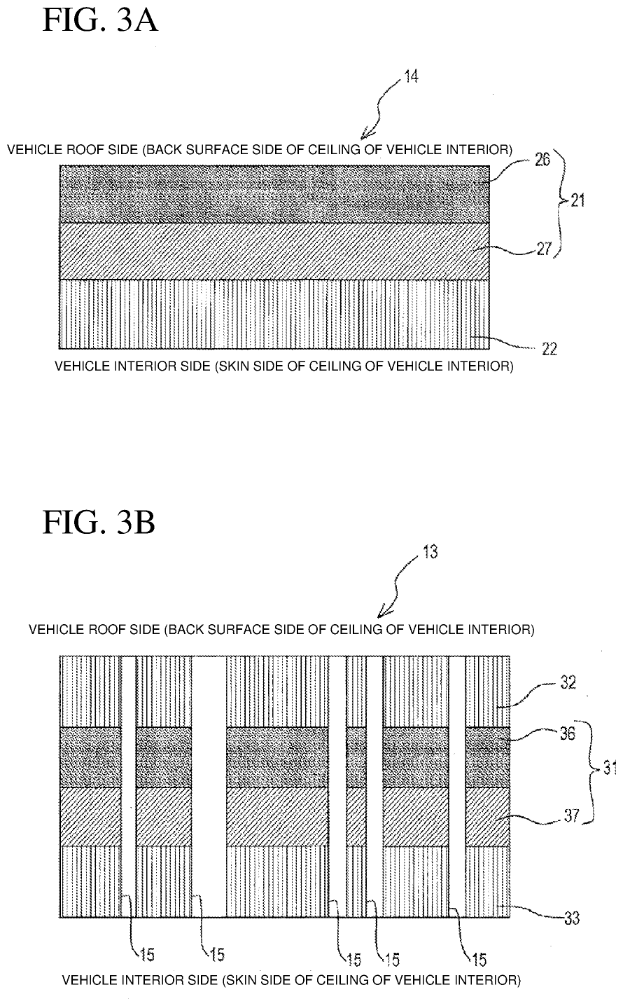

In the above-described embodiment, the back surface layer 14 is configured such that the resin film 27 is arranged on an upper surface of the metal foil 26, and the hot-melt layer 22 is arranged on a lower surface of the metal foil 26. However, there is no limitation to the above-described embodiment. For example, the back surface layer 14 may be configured such that the resin film 27 is arranged on the lower surface of the metal foil 26, and the hot-melt layer 22 is arranged on a lower surface of the resin film 27, as illustrated in FIG. 3A.

In the above-described embodiment, the adhesive layer 13 is configured such that the resin film 37 is arranged on an upper surface of the metal foil 36, the hot-melt layer 33 is arranged on a lower surface of the metal foil 36, and the hot-melt layer 32 is arranged on an upper surface of the resin film 37. However, there is no limitation to the above-described embodiment. For example, the adhesive layer 13 may be configured such that the resin film 37 is arranged on the lower surface of the metal foil 36, the hot-melt layer 33 is arranged on a lower surface of the resin film 37, and the hot-melt layer 32 is arranged on the upper surface of the metal foil 36, as illustrated in FIG. 3B.

### Modified Example 3

The resin film 27 exemplified in the above-described embodiment has an elongation percentage higher than that of the metal foil 26. However, there is no limitation to the above-described embodiment. For example, even when the resin film 27 has an elongation percentage lower than that of the metal foil 26, the resin film 27 and the metal foil 26 may be laminated with each other so as to have an elongation percentage higher than that of the metal foil 26.

Similarly, the resin film 37 exemplified in the above-described embodiment has an elongation percentage higher than that of the metal foil 36. However, there is no limitation to the above-described embodiment. For example, even when the resin film 37 has an elongation percentage lower than that of the metal foil 36, the resin film 37 and the metal foil 36 may be laminated with each other so as to have an elongation percentage higher than that of the metal foil 36.

### Reference Signs List

1 Vehicle ceiling material
1a Flat portion
1b Stepped portion
11 Base material
12 Skin material layer
13 Adhesive layer
14 Back surface layer
15 Hole
21 Layered film
22 Hot-melt layer
26 Metal foil
27 Resin film
31 Layered film
32, 33 Hot-melt layer
36 Metal foil
37 Resin film
121 Skin layer
122 Lamination urethane layer

1. A vehicle ceiling material comprising:
a base material;
a skin material layer arranged at a surface on a vehicle interior side in the base material and forming a ceiling surface in a vehicle interior;
an adhesive layer between the base material and the skin material layer; and
a back surface layer arranged on a surface on a vehicle roof side in the base material,
wherein at least one of the adhesive layer and the back surface layer includes a layered film, the layered film including a metal foil and a resin film, the metal foil having a thickness equal to or larger than 10 μm and equal to or smaller than 100 μm, the metal foil and the resin film being laminated with each other, the layered film having an elongation percentage higher than that of the metal foil, and
the layered film is used as the adhesive layer.

2. The vehicle ceiling material according to claim 1,
wherein the layered film is used as the back surface layer, and
the resin film is arranged on a vehicle roof side, and the metal foil is arranged on a vehicle interior side.

3. The vehicle ceiling material according to claim 1,
wherein the skin material layer and the base material are adhered to each other by a hot-melt layer, and
the hot-melt layer contacting with the resin film of the adhesive layer is made mainly of a same material as that of the resin film.

4. The vehicle ceiling material according to claim 1, wherein a plurality of holes are formed in the adhesive layer, the plurality of holes connecting the skin material layer and the base material to each other.

5. The vehicle ceiling material according to claim 2,
wherein the skin material layer and the base material are adhered to each other by a hot-melt layer, and
the hot-melt layer contacting with the resin film of the adhesive layer is made mainly of a same material as that of the resin film.

6. The vehicle ceiling material according to claim 2, wherein
a plurality of holes are formed in the adhesive layer, the plurality of holes connecting the skin material layer and the base material to each other.

7. The vehicle ceiling material according to claim 3, wherein
a plurality of holes are formed in the adhesive layer, the plurality of holes connecting the skin material layer and the base material to each other.
